(19) United States
(12) Patent Application Publication
(10) Pub. No.: US 2003/0093699 A1
(43) Pub. Date: May 15, 2003

(54) Graphical passwords for use in a data processing network

(75) Inventors: Kenneth Ray Banning, Austin, TX (US); Tai Anh Cao, Austin, TX (US); Khanh Nguyen, Austin, TX (US)

Correspondence Address: Joseph P. Lally, DEWAN & LALLY, L.L.P., P.O. Box 684749, Austin, TX, 78768-4749, US

(73) Assignee: International Business Machines Corporation, Armonk, NY (US)

(21) Appl. No.: 09/998,402

(22) Filed: Nov. 15, 2001

(51) Int. Cl. H04L 9/32

(52) U.S. Cl. 713/202

(57) ABSTRACT

A method and system for authorizing access to networked information using a graphically based password. In one embodiment, access to a restricted document is granted only after the user has demonstrated its authority to access the information by identifying a previously determined sequence of graphical images. If the user identifies the correct images, the user is granted access to the restricted information. In one embodiment, the graphical images may be presented to the user as a sequence of web pages where each page has multiple graphical images (icons). On each page in the sequence, the user selects (such as by clicking) the correct icon. The icon may be implemented as a link to the next web page in the password sequence. As each page is presented, the user clicks the correct icon thereby generating a sequence of accessed web pages. The server then verifies the user as an authorized user by comparing the sequence of web pages visited by the user to a predetermined sequence. In this manner, the password enabling a user to access confidential information comprises a sequence of web pages visited by the user. The graphically based password information may be supplemented with user identification information that is either entered by the user or provided by the user as cookie information. In this embodiment, the server may grant various levels of access based on the combination of the user identification information and the graphically entered password.

### BACKGROUND

1. Field of the Present Invention

The present invention relates to the field of data processing networks and more particularly to a system and method for authorizing a client to access restricted information over a computer network such as the Internet.

2. History of Related Art

Data processing networks are widely implemented to provide distributed information and services to a large number of network clients who may be geographically dispersed over a wide area. The Internet, as the most universally recognizable data processing network, enables most clients to request information from thousands of servers without regard to the particular hardware or platform employed by the client, the targeted server, or any intervening network device.

While much of the information on a network is designed to be freely accessed by any user, other information is designed to be accessed only by authorized users. One common method of restricting access to network information is the use of one or more passwords. In a conventional password implementation, a user is prompted to enter an alphanumeric sequence in response to a request for access to information deemed to be confidential. If the sequence entered by the user matches a sequence stored in a server-side database, the server grants the user access to the restricted information.

As the use of data processing networks has proliferated, the amount of information that is accessible via networks has increased correspondingly. Accordingly, a user may be able to access information for many different accounts that the user may have. A user, for example, may have several credit cards and bank accounts that provide account balances and statements via the Internet. Inevitably, access to any financial information is restricted to the authorized owner of the account frequently through the use of passwords. While some passwords are generated by the user, others may be assigned by the account provider. Thus, a single consumer or business user may find that it must keep track of one or more passwords for a large number of accounts.

Alphanumeric passwords are generally difficult to remember for many individuals. The proliferation of graphical user interfaces in computer systems attests to the fact that it is generally easier for many people to interact with a graphical interface than with a text-based interface. In addition, alphanumeric sequences are typically restricted to a particular alphabet. Users of a network or web site that are not native to the designated alphabet may experience additional difficulty trying to remember an alphanumeric sequence in a foreign alphabet. It would, therefore, be desirable to implement a system and method for authorizing access to confidential and otherwise restricted information that did not rely on the use of alphanumeric sequences.

### SUMMARY OF THE INVENTION

The problems identified above are addressed by a method and system for authorizing access to networked information using a graphically based password. In one embodiment, access to a restricted document is granted only after the user has demonstrated its authority to access the information by identifying a previously determined sequence of graphical images. If the user identifies the correct images, the user is granted access to the restricted information. In this manner, the network maintains restricted access to confidential and secure information using graphical images that are generally easier for many users to recall.

In one embodiment, the graphical images may be presented to the user as a sequence of web pages where each page has multiple graphical images (icons). On each page in the sequence, the user selects (such as by clicking) the correct icon. The icon may be implemented as a link to the next web page in the password sequence. As each page is presented, the user clicks the correct icon thereby generating a sequence of accessed web pages. The server then verifies the user as an authorized user by comparing the sequence of web pages visited by the user to a predetermined sequence. In this manner, the password enabling a user to access confidential information comprises a sequence of web pages visited by the user.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing network suitable for use with one embodiment of the invention;

FIG. 2 illustrates a representative screen for use with a system and method for using graphical passwords according to one embodiment of the invention; and

FIG. 3 is a flow diagram illustrating a method of authorizing a user with graphical passwords according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

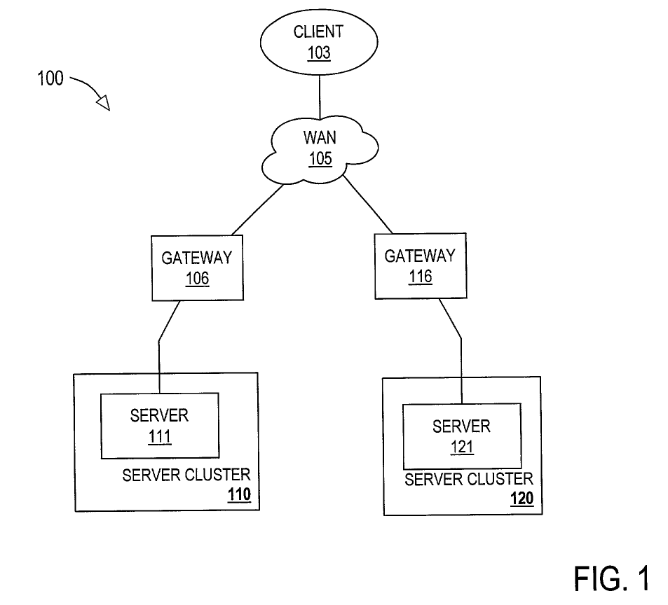

Before describing details of the invention, a general description of a data processing network suitable for employing the invention is presented to provide context for the subsequent discussion. Referring to FIG. 1, a block diagram of selected features of a data processing network 100 suitable for use in one embodiment of the present invention is shown. In the depicted embodiment, data processing network 100 includes a first server cluster 110 that is connected to a wide area network (WAN) 105 through an intermediate gateway 106 and a second server cluster 120 connected to WAN 105 through a second gateway 116. WAN 105 may include a multitude of various network devices including gateways, routers, hubs, and so forth as well as one or more local area networks (LANs) all interconnected over a potentially wide-spread geographic area. WAN 105 may represent the Internet in one embodiment.

Server cluster 110 may include one or more server devices (servers) 111 as well as additional network devices such as a network switch and networked storage devices all connected in a shared media or point-to-point local area network (LAN) configuration. In its simplest embodiment, server cluster 110 comprises a single server 111 connected to WAN 105. Server cluster 110 may represent a particular universal resource indicator (URI) on data processing network 100 such that all network requests specifying the URI are routed to and processed by server cluster 110. Server 111 includes a system memory and at least one processor capable of accessing data and instructions stored in the system memory as is typical in the field.

Network 100 further includes a second server cluster 120 connected to WAN 105. Second server cluster 120, like first server cluster 110, includes at a minimum a server device 121 and may include additional servers and network devices. Second server cluster 120 typically represents a second URI on network 100. Network requests that reference the second URI are directed to and processed by second server cluster 120.

To accommodate the potentially disparate platforms of various network devices, data processing networks typically employ a network protocol that provides a common set of rules and specifications with which network aware applications must comply to communicate via the network.

Network protocols are typically described as comprising a set of protocol layers starting with a lowest layer concerned with the network's physical media to a highest layer that specifies end-user and end-application protocols. The Open Systems Interconnect (OSI) Reference Model, for example, identifies seven layers of a typical network protocol stack.

Each layer defines the protocols and functions related to a specific portion of the network communication process. These layers include a network layer protocol such as the Internet Protocol (IP) that defines the manner in which network connections are established and maintained and a transport layer protocol such as the Transmission Control Protocol (TCP) that ensures the integrity and reliability of messages exchanged via a network connection. The TCP/IP suite of protocols provides the backbone for a large number of data processing networks including the Internet. The IP and TCP specifications are publicly available as RFC's 791 and 793 respectively from the Internet Engineering Task Force (IETF) at www.ietf.org.

A variety of application layer protocols can execute on top of a TCP/IP compliant network. Among the more commonly encountered of such protocols is the Hypertext Transfer Protocol (HTTP) as defined in IETF RFC 2616. In a typical HTTP sequence, a client application such as a conventional web browser initiates a GET request that specifies the URI of the resource from which information is desired (the request-URI). The request is routed to the request-URI, which then responds by returning a file, executing an application such as a cgi script, or a combination of both.

HTTP employs one or more headers to convey information that can be used to modify the manner in which an HTTP request is processed. Among the headers specified by HTTP is the request header, that includes a field, referred to as the referer (sic) field. The referer field allows the client to specify the URI of the resource from which the request-URI was obtained (the “referrer”). The referer field enables a server to generate lists of back-links to resources for interest, logging, and optimized caching. It also allows obsolete or mistyped links to be traced for maintenance.

HTTP is a “stateless” protocol in which requests and responses are independent of previous requests and responses. To facilitate a wide variety of client-server sessions, many servers generate state information that can be used to differentiate and customize interactions with various clients. State information may be used in HTTP, for example, to identify a particular client session to facilitate shopping cart transactions. HTTP state information mechanisms are detailed in D. Kristol et al., HTTP State Management Mechanism, RFC 2965 (IETF 2000) and K. Moore et al., Use of HTTP State Management, RFC 2964 (IETF 2000). When a client issues an HTTP request to a server, the server may attempt to send state information (also referred to as “cookie” information or simply a cookie) to the client. If the client accepts the cookie, the client may then send the cookie with any subsequent requests to the server. In this manner, the server may differentiate among a potentially huge number of otherwise identical requests.

Generally speaking, the invention contemplates authorizing access to networked documents or other information by prompting a user to select a sequence of graphical images. The sequence of graphical images serves in lieu of an alphanumeric password. If the image sequence selected by the user is verified against a previously determined sequence, the user is granted access to the corresponding document or information. The use of graphical images beneficially frees users from having to remember one or more alphanumeric passwords that are notoriously easy to forget without compromising the security of the confidential information.

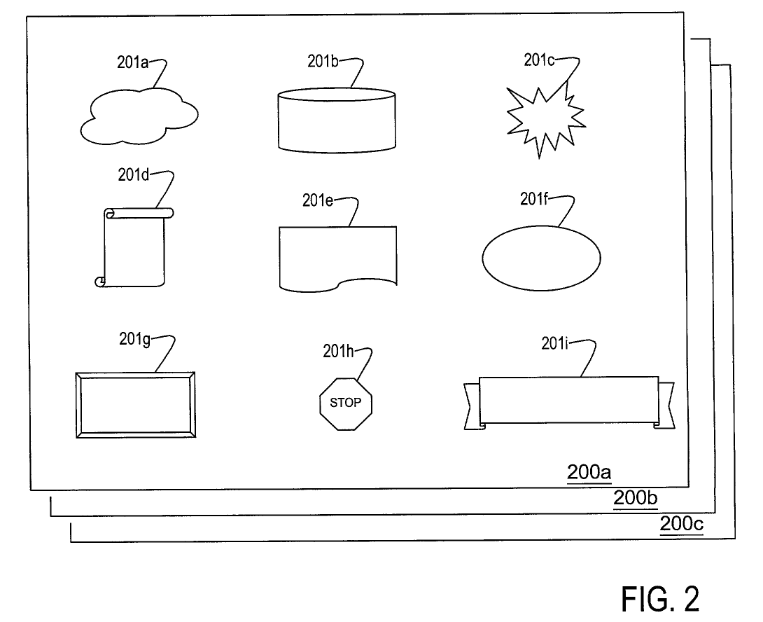

Turning now to FIG. 2, a representative series of documents 200a through 200c (generically or collectively referred to as documents(s) 200) that a user would encounter during an authorization sequence according to one embodiment of the invention is depicted. Typically, the user is presented with documents 200 in response to a request for confidential or otherwise restricted information on a network. In a typical application, the network represents the Internet and the user makes the request via a client application such as a conventional web browser. In this application, the client request contains a URL identifying a server that will handle the request. Upon detecting a request for restricted information, the URL server will generate a document, such as the document 200a depicted in FIG. 2, containing a set of graphical images or icons 201a through 201i (generically or collectively referred to as icon(s) 201). The user is then prompted to select an icon 201. In response to the user clicking an icon 201, the server records the selected icon and displays a second document 200b to the user. Like first page 200a, second page 200b typically includes a set of icons from which the user must select one. The user is thus prompted through a sequence of documents or screens clicking on one of the icons for each screen presented.

Each of the icons may be associated with an HTML link to a corresponding page in the sequence of documents. As the user selects an icon 201 from each screen 200, the user generates a sequence of web pages visited. The URL server may then compare the sequence of web pages visited against a previously determined sequence of web pages to determine if the user is granted access to the restricted information. If the sequence entered by the user matches the previously determined sequence, the server grants the user access to the confidential or restricted information typically without regard to other information associated with the client such as the client ID.

If the sequence entered by the user differs from the previously determined sequence, the user may be unconditionally prevented from accessing the requested information. In another embodiment, the user-entered sequence of icons may be further enhanced with user identification (userid) information to supplement the verification process and/or provide additional levels of authorization. The userid information may be included with the server response and returned with subsequent requests as cookie information. In this embodiment, the server sends the cookie userid information when a request is received from the user for the first time. If the user's client accepts the cookie, the cookie is sent back to the server with each subsequent request to the server.

The combined use of userid information and icon sequence information enables varying levels of authorization. Imagine, for example, that it is desirable to grant “read-only access” to a group of users while providing full access privileges to only a single user. To accomplish this implementation, the selected sequence of icons may be used to provide the password while the userid information identifies the requester. If the sequence of selected images is correct, the client may be granted read access to the requested document(s). If, in addition, the userid is known by the server as an authorized userid, the user may be granted fall access privileges to the documents.

Portions of the present invention may be implemented as a sequence of processor executable instructions (software) for granting access to a client using graphical images in lieu of an alphanumeric password. The instructions are typically stored on a computer readable medium. When the instructions are being executed, the instructions are typically stored in a volatile storage facility such as the dynamic RAM host memory or an internal or external cache memory of the processors. At other times, when the code is not being executed, the software may reside on a slower but less volatile storage device such as a networked storage box, a floppy diskette, a local hard drive, CD ROM, DVD, magnetic tape, or another suitable storage medium.

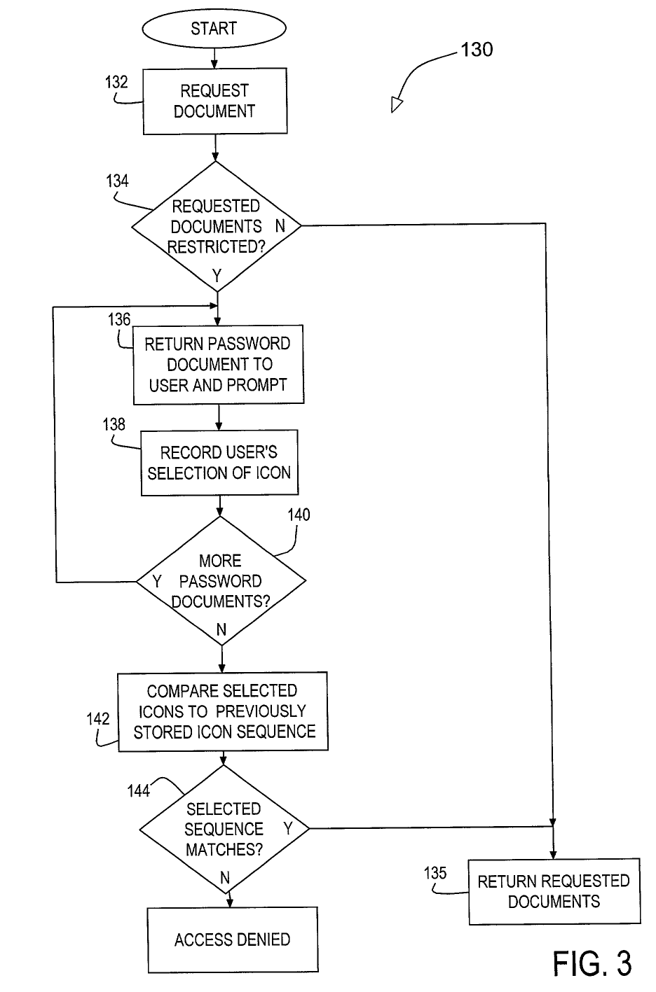

Turning now to FIG. 3, a flow diagram illustrating a method 130 for authorizing access to confidential or restricted access documents or information in a data processing network is presented. Initially, a user requests (block 132) a networked document or other information. The request is typically in the form of an HTTP request (such as a GET request) generated by a conventional web browser. The request is received by a server that corresponds to the URL indicated in the request. Upon receiving the request, the server determines (block 134) whether the request is for documents or other information to which access is restricted to authorized users only. If the server determines that the requested document is not access restricted, it retrieves or otherwise generates the requested document and returns (block 135) the document to the requesting client.

If, however, the server determines that the requested document is access restricted, the server may then generate (block 136) a document (referred to herein as a password document) such as the document 200 depicted in FIG. 2 containing a set of graphical images or icons and prompt the user to select at least one of the icons. After the user selects an icon from the first password document, the server typically records (block 138) the selected icon. In an embodiment where each of the icons is an HTML link to another password document of the server, the server may record the selected icons by monitoring the sequence of web pages visited during the password entry process. After recording a user's selection for a password page, the server determines (block 140) if additional password pages should be generated.

The number of password pages (i.e. graphical images in the password) may be a fixed number or may be variable. In the case of a fixed number, the determination of whether to generate additional password pages is made by monitoring the number of password pages that have been presented to the user. In the case of a variable number of password pages, each password page may contain an icon that enables the user to terminate the password entry sequence. The user would select this icon after selecting the number of graphical images corresponding to his or her password.

Following the selection of a sequence of graphical images by the user (whether in the case of a fixed length password or a variable length password), the server then compares (block 142) the sequence of icons selected by the user against a previously determined sequence of icons that may be stored on a non-volatile storage device accessible to the server. If the server determines (block 144) that the entered sequence matches the previously determined sequence, the server retrieves and/or generates the requested document and returns it to the client. If the selected sequence of images does not match the previously selected sequence, the server denies the client access to the requested documents.

The method 130 may be elaborated upon through the use of userid information in conjunction with the graphically based password information. In this embodiment, the client may be prompted to enter user identification information before performing the password entry sequence. Alternatively, the user identification information may consist of cookie information previously generated by the server, which is being returned to the server by the client with the document request. In either embodiment, the server may compare the password and user identification information against previously recorded information to grant or deny access to the requested documents. In another embodiment, the server may grant limited access, such as readonly access, if either the user identification information or the password information (but not both) is recognized by the server.

It will be apparent to those skilled in the art having the benefit of this disclosure that the present invention contemplates a method and system for granting access to privileged documents in a network environment. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method of authorizing access to restricted information on a data processing network, comprising:
responsive to receiving a request for a document, determining whether access to the document is restricted;
responsive to determining that access to the requested document is restricted, providing at least one password document comprising a plurality of icons to a user for selection by the user;
detecting a user's selection of one or more icons from the at least one password documents and, based thereon, determining the user's authority to access the requested documents.

2. The method of claim 1, wherein providing at least one password document comprises providing a series of password documents to the user, each password document comprising a plurality of icons and prompting the user to select one of the icons from each of the password documents.

3. The method of claim 2, wherein a correct icon on each password document comprises a link to a next password document such that selecting an appropriate sequence of icons produces a corresponding sequence of documents.

4. The method of claim 1, wherein determining the user's authority to access a requested document comprises comparing the sequence of selected icons to a previously stored sequence and granting authority if the selected sequence matches the previously stored sequence.

5. The method of claim 1, further comprising, reading user identification information provided with the request and determining authority to access the requested document based on the selected icons and the user identification information.

6. The method of claim 5, wherein the user identification information is provided as a cookie portion of the request.

7. The method of claim 5, wherein the user is provided read only access authority to the requested document if the user identification information matches previously stored user identification information.

8. A computer program product comprising a set of computer executable instructions for authorizing access to restricted information on a data processing network, the instruction stored on a computer readable medium, comprising:
computer code means for determining whether access to the document is restricted responsive to receiving a request for a document;
computer code means responsive to determining that access to the requested document is restricted for providing at least one password document comprising a plurality of icons to a user for selection by the user;
computer code means for detecting a user's selection of one or more icons from the at least one password documents and, based thereon, determining the user's authority to access the requested documents.

9. The computer program product of claim 8, wherein the code means for providing at least one password document comprises code means for providing a series of password documents to the user, each password document comprising a plurality of icons and code means for prompting the user to select one of the icons from each of the password documents.

10. The computer program product of claim 9, wherein a correct icon on each password document comprises a link to a next password document such that selecting an appropriate sequence of icons produces a corresponding sequence of documents.

11. The computer program product of claim 8, wherein the code means for determining the user's authority to access a requested document comprises code means for comparing the sequence of selected icons to a previously stored sequence and granting authority if the selected sequence matches the previously stored sequence.

12. The computer program product of claim 8, further comprising, computer code means for reading user identification information provided with the request and determining authority to access the requested document based on the selected icons and the user identification information.

13. The computer program product of claim 12, wherein the user identification information is provided as a cookie portion of the request.

14. The computer program product of claim 12, wherein the user is provided read only access authority to the requested document if the user identification information matches previously stored user identification information.

15. A data processing system including processor, memory, and input means connected via a bus, the memory containing at least a portion of a computer program product comprising a set of computer executable instructions for authorizing access to restricted information on a data processing network, the instruction stored on a computer readable medium, comprising:
computer code means for determining whether access to the document is restricted responsive to receiving a request for a document;
computer code means responsive to determining that access to the requested document is restricted for providing at least one password document comprising a plurality of icons to a user for selection by the user;
computer code means for detecting a user's selection of one or more icons from the at least one password documents and, based thereon, determining the user's authority to access the requested documents.

16. The data processing system of claim 15, wherein the code means for providing at least one password document comprises code means for providing a series of password documents to the user, each password document comprising a plurality of icons and code means for prompting the user to select one of the icons from each of the password documents.

17. The data processing system of claim 16, wherein a correct icon on each password document comprises a link to a next password document such that selecting an appropriate sequence of icons produces a corresponding sequence of documents.

18. The data processing system of claim 15, wherein the code means for determining the user's authority to access a requested document comprises code means for comparing the sequence of selected icons to a previously stored sequence and granting authority if the selected sequence matches the previously stored sequence.

19. The data processing system of claim 15, further comprising, computer code means for reading user identification information provided with the request and determining authority to access the requested document based on the selected icons and the user identification information.

20. The data processing system of claim 19, wherein the user identification information is provided as a cookie portion of the request.

21. The data processing system of claim 19, wherein the user is provided read only access authority to the requested document if the user identification information matches previously stored user identification information.
